(19) United States
(12) Patent Application Publication
(10) Pub. No.: US 2012/0005641 A1
(43) Pub. Date: Jan. 5, 2012

(54) SEMICONDUCTOR DESIGNING APPARATUS

(75) Inventors: Masanori KURIMOTO, Kanagawa (JP); Takashi Tsukamoto, Kanagawa (JP); Yoshio Inoue, Kanagawa (JP)

(73) Assignee: Renesas Electronics Corporation

(21) Appl. No.: 13/166,349

(22) Filed: Jun. 22, 2011

(30) Foreign Application Priority Data
Jul. 2, 2010 (JP) 2010-152268

(51) Int. Cl. G06F 9/455

(52) U.S. Cl. 716/108

(57) ABSTRACT

The present invention provides a semiconductor designing apparatus realizing dispersed power consumption timings without causing a setup violation and a hold violation. An STA unit calculates a setup slack as a margin of setup time of a flip-flop on the basis of a present design value of a clock latency of the flip-flop. Based on the calculated setup slack, an HSLD unit adjusts the clock latency of the flip-flop so as to be advanced more than a present design value without causing a timing violation. When a peak equal to or larger than a threshold value remains in the number of synchs in a clock latency distribution as a result of the latency control of the HSLD unit, a PAS unit smoothes the clock latency of the flip-flop without causing a timing violation on the basis of the timing information recalculated by the HSLD unit.

### CROSS-REFERENCE TO RELATED APPLICATIONS

The disclosure of Japanese Patent Application No. 2010-152268 filed on Jul. 2, 2010 including the specification, drawings and abstract is incorporated herein by reference in its entirety.

### BACKGROUND

The present invention relates to a semiconductor designing apparatus.

The main stream of LSI (Large-Scale Integration) designing in recent years is synchronization designing. In the synchronization designing, all of registers are configured by flip-flops and operate synchronously with clocks. For higher speed, a skew is suppressed in a clock supplied to each of the flip-flops, and clocks are supplied in the same phase. Consequently, power consumption is concentrated at the rising and trailing edges of clocks. The concentration of power consumption causes a dynamic drop of a power supply and EMI (Electro Magnetic Interference) noise, and a problem such as decrease in reliability of the chip occurs.

To address such a problem, for example, in an apparatus disclosed in patent document 1 (Japanese Unexamined Patent Publication No. 2004-192201), a clock is output to a flip-flop via a selector for selecting one of a plurality of clocks from different nodes of a plurality of delay circuits that delay clocks. By controlling selection of the selector with pseudo random numbers, the timings of power consumption can be dispersed.

### DOCUMENT OF RELATED ART

### Patent Document

### [Patent Document 1]

Japanese Unexamined Patent Publication No. 2004-192201

### SUMMARY

In the apparatus of the patent document 1, the clock supplied to the flip-flop is selected by the pseudo random number. The area overhead for generating the pseudo random number is large, and the clocks are not satisfactorily dispersed.

Therefore, an object of the present invention is to provide a semiconductor designing apparatus realizing dispersed timings of consuming power without causing a setup violation and a hold violation.

An embodiment of the present invention is a semiconductor designing apparatus for adjusting a clock latency of a flip-flop designed by logic synthesis. The semiconductor designing apparatus includes: a slack analysis unit for calculating a setup slack as a margin of setup time of a flip-flop on the basis of a present design value of the clock latency of the flip-flop; and a first clock latency adjustment unit for adjusting the clock latency of the flip-flop so as to be advanced more than the present design value on the basis of the calculated setup slack without causing a timing violation.

According to the embodiment of the invention, without causing a setup violation and a hold violation, power consumption timings can be dispersed.

### BRIEF DESCRIPTION OF THE DRAWINGS

FIG. 1 is a diagram illustrating the configuration of a semiconductor designing apparatus of a semiconductor integrated circuit of a first embodiment.

FIG. 2 is a diagram for explaining a setup slack SS and a hold slack HS.

FIG. 3 is a flowchart showing a designing process performed by the semiconductor designing apparatus of the first embodiment.

FIG. 4 is a flowchart showing the procedure of step S903 in FIG. 3.

FIG. 5 is a flowchart showing the procedure of HSLD in step S904 in FIG. 3.

FIG. 6 is a diagram showing an example of clock latency before the HSLD is applied.

FIG. 7 is a diagram showing an example of clock phases in the method of retarding the phase of a clock in the ante stage only by the amount of the setup slack.

FIG. 8 is a diagram showing an example of clock phases after application of the HSLD of the embodiment.

FIG. 9 is a diagram for explaining an example of designs used for evaluating the performance of the embodiment.

FIG. 10 is a diagram of comparison between power consumption in the case of applying the HSLD of the embodiment and power consumption in the case of a related art in which the HSLD is not applied.

FIG. 11 is a diagram showing an example of a clock tree generated by a method of the related art.

FIG. 12 is a diagram showing a timing chart based on the clock tree of FIG. 11.

FIG. 13 is a diagram showing an example of a clock tree generated in the embodiment.

FIG. 14 is a diagram showing a timing chart based on the clock tree of FIG. 13.

FIG. 15 is a diagram showing comparison between power consumption in the case of applying the HSLD of the embodiment and power consumption in the case of a related art in which the HSLD is not applied with respect to design 2 in FIG. 9.

FIG. 16 is a diagram showing a frequency distribution (histogram) of clock latency DC before the HSLD is applied.

FIG. 17 is a diagram showing a frequency distribution (histogram) of clock latency DC after the HSLD is applied.

FIG. 18 is a diagram showing an example where a setup slack remains after application of the HSLD.

FIG. 19 is a diagram showing a frequency distribution of the setup slack SS after application of the HSLD to peak P1 in FIG. 17.

FIG. 20 is a diagram showing the configuration of a semiconductor designing apparatus of a second embodiment.

FIG. 21 is a flowchart showing a designing procedure by the semiconductor designing apparatus of the second embodiment.

FIG. 22 is a flowchart showing a procedure of PAS in step S202 in FIG. 21.

FIG. 23 is a diagram showing comparison among power consumption in the case of applying the HSLD of the first embodiment, power consumption in the case of applying the PAS of the second embodiment in addition to the HSLD of the first embodiment, and power consumption of a related art in which the HSLD is not applied with respect to design 2 in FIG. 9.

### DETAILED DESCRIPTION

In the following, embodiments of the present invention will be described with reference to the drawings.

### First Embodiment

In a first embodiment of the invention, a slack (timing allowance of clock latency for a data path delay) is calculated by a timing analyzing method, and the phases of clocks supplied to flip-flops (D latch) are dispersed without causing a timing violation on the basis of the calculated slack, thereby dispersing the timings of consuming power.

### Configuration of Semiconductor Designing Apparatus

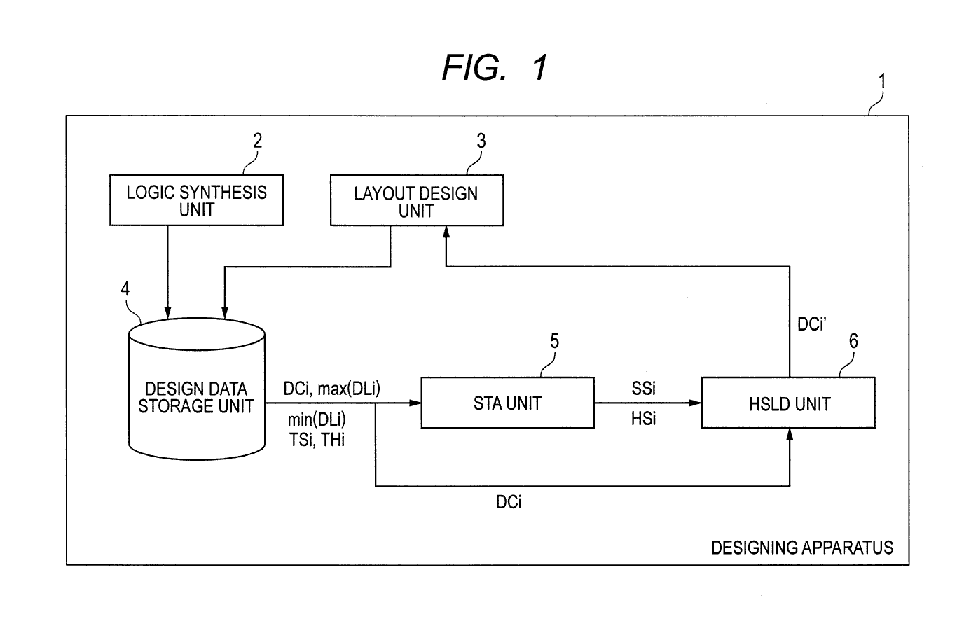

FIG. 1 is a diagram showing the configuration of a semiconductor designing apparatus of a first embodiment.

Referring to FIG. 1, a semiconductor designing apparatus 1 has a logic synthesis unit 2, a layout design unit 3, a design data storage unit 4, an STA (Static Timing Analysis) unit 5, and an HSLD (Hold-driven Slack-based Latency Distribution) unit 6.

The logic synthesis unit 2 generates an initial net list on a clock tree and stores it in the design data storage unit 4.

The layout design unit 3 generates initial layout data on the basis of the net list and stores it in the design data storage unit 4. The layout design unit 3 updates the layout data on the basis of the updated net list and stores the updated data in the design data storage unit 4. The layout design unit 3 reconstructs the clock tree on the basis of clock latency newly calculated by the HSLD unit 6 and updates the net list.

The design data storage unit 4 stores the net list generated by the logic synthesis unit 2 and the layout data generated by the layout design unit 3.

The STA unit 5 calculates a setup slack SS and a hold slack HS on the basis of a data path delay, the initial clock latency, a setup constraint, and a hold constraint stored in the design data storage unit 4.

The data path delay is a data transfer delay in a data path to the flip-flop and there are the following three kinds of the data path delays.

(1) A data path delay which occurs between a primary input and a data input pin of a flip-flop FF at the first stage, (2) a data path delay which occurs between flip-flops FF (from the rising edge (or trailing edge) of a clock to a flip-flop FF to a data input pin of a flip-flop FF at the next stage via a data output pin of the flip-flop FF), and (3) a data path delay which occurs between the rising edge (or the trailing edge) of a clock to a flip-flop FF and a primary output (output pin).

The clock latency denotes time in which a clock CLK from the origin of a clock tree is input to a flip-flop FF via the clock path.

The setup constraint for a flip-flop Fi is a value indicating time by which data to be supplied to the flip-flop Fi has to arrive before a clock CLK to be supplied to the flip-flop Fi.

The hold constraint for the flip-flop Fi is a value indicating time in which data to be supplied to the flip-flop Fi has to be maintained after the clock CLK is supplied to the flip-flop Fi.

The setup slack SS denotes a margin value for the timing specified in the setup constraint. In the case where the setup slack SSi for the flip-flop Fi is positive, the timing relation between the data path delay of the data which is supplied to the flip-flop Fi and the clock latency of the flip-flop Fi satisfies the setup constraint timing condition. Even when the phase of the clock CLK which is supplied to the flip-flop Fi is advanced only by the setup slack SSi at the maximum, the timing relation between the data path delay of the data which is supplied to the flip-flop Fi and the clock latency of the flip-flop Fi satisfies the setup constraint timing condition. On the other hand, in the case where the setup slack SSi is negative, the timing relation between the data path delay of the data which is supplied to the flip-flop Fi and the clock latency of the flip-flop Fi does not satisfy the setup constraint timing condition (setup violation).

The hold slack HS denotes a margin value for the timing specified in the hold constraint. In the case where the hold slack HSi for the flip-flop Fi is positive, the timing relation between the data which is supplied to the flip-flop Fi and the clock latency of the flip-flop Fi satisfies the hold constraint timing condition. Even when the phase of the clock CLK which is supplied to the flip-flop Fi is retarded only by the hold slack HSi at the maximum, the timing relation between the data which is supplied to the flip-flop Fi and the clock latency of the flip-flop Fi satisfies the hold constraint timing condition. On the other hand, in the case where the hold slack HSi is negative, the timing relation between the data which is supplied to the flip-flop Fi and the clock latency of the flip-flop Fi does not satisfy the hold constraint timing condition (hold violation).

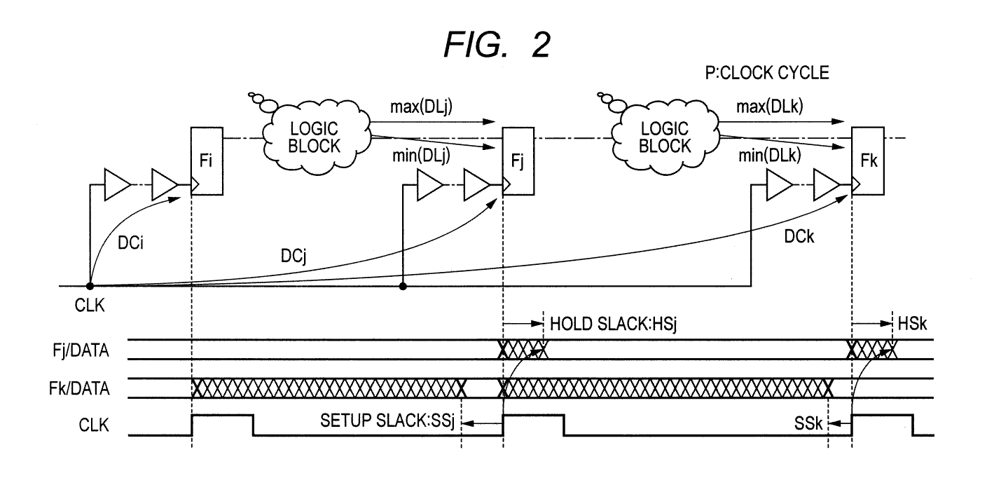

FIG. 2 is a diagram for explaining the setup slack SS and the hold slack HS.

It is assumed here that flip-flops Fi, Fj, and Fk are connected in series. The cycle of the clock CLK is set to P.

The clock latencies of the flip-flops Fi, Fj, and Fk are set to DCi, DCj, and DCk, respectively. The maximum data path delay to the flip-flop Fj is set as max(DLj) and the minimum data path delay is set as min(DLj). The maximum data path delay to the flip-flop Fk is set as max(DLk) and the minimum data path delay is set as min(DLk).

The setup constraint and the hold constraint for the flip-flop Fj are set as TSj and THj, respectively. The setup constraint and the hold constraint for the flip-flop Fk are set as TSk and THk, respectively.

The setup slacks SSj and SSk and the hold slacks HSj and HSk for the flip-flops Fj and Fk can be expressed by the following equations.

SSj=P−DCi−max(DLj)−TSj+DCj (1)

HSj=DCi+min(DLj)−DCj−THj (2)

SSk=P−DCj−max(DLk)−TSk+DCk (3)

HSk=DCj+min(DLk)−DCk−THk (4)

In the case of FIG. 2, therefore, the STA unit 5 calculates the setup slacks SSj and SSk and the hold slacks HSj and HSk in accordance with the equations (1) to (4).

### HSLD

The HSLD unit 6 adjusts the clock latency of a flip-flop on the basis of the setup slacks and the hold slacks calculated by the STA unit 5. At the time of adjusting the clock latency of the flip-flop, the HSLD unit 6 adjusts the clock latency of the flip-flop so as to be advanced more than the design value at present on the basis of the setup slack of the flip-flop and the hold slack of a flip-flop which is at the post stage of the flip-flop without causing a setup violation and a hold violation. The detailed process of the HSLD unit 6 will be described later.

### Operation Procedure

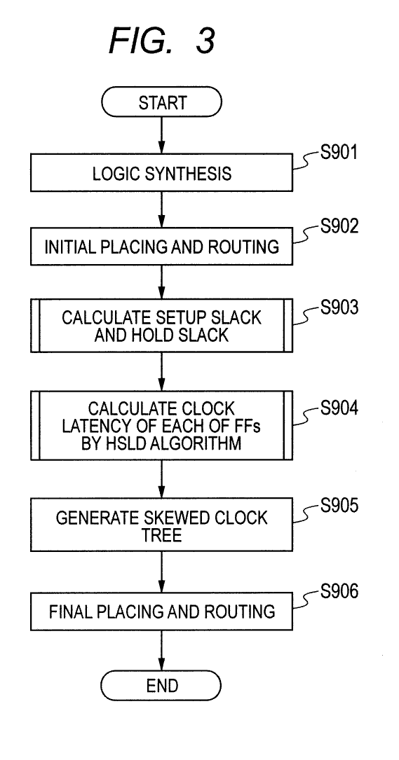

FIG. 3 is a flowchart showing a designing process performed by the semiconductor designing apparatus of the first embodiment.

First, the logic synthesis unit 2 generates an initial net list (including initial clock latency, setup constraint, hold constraint, and data of data path delay) on a clock tree starting from the clock source and extending to a circuit element group at the end from RTL (Register Transfer Level) description configured by a flip-flop and a combination circuit and stores it in the design data storage unit 4 (step S901).

Next, the layout design unit 3 places gates without any space and routes terminals of the gates on the basis of the net list, thereby generating initial layout data, and stores the data in the design data storage unit 4 (step S902).

Using the data included in the initial net list, the STA unit 5 calculates the setup slack and the hold slack of the flip-flop FF (step S903).

The HSLD unit 6 calculates a new clock latency for each of the flip-flops FF on the basis of the setup slack and the hold slack calculated in step S903 (step S904).

The layout design unit 3 updates the net list by reconstructing the clock tree generated in step S901 to a skewed clock tree on the basis of the newly calculated clock latency (step S905).

Further, the layout design unit 3 updates the layout data on the basis of the updated net list and stores the updated data in the design data storage unit 4 (step S906).

### Procedure of STA

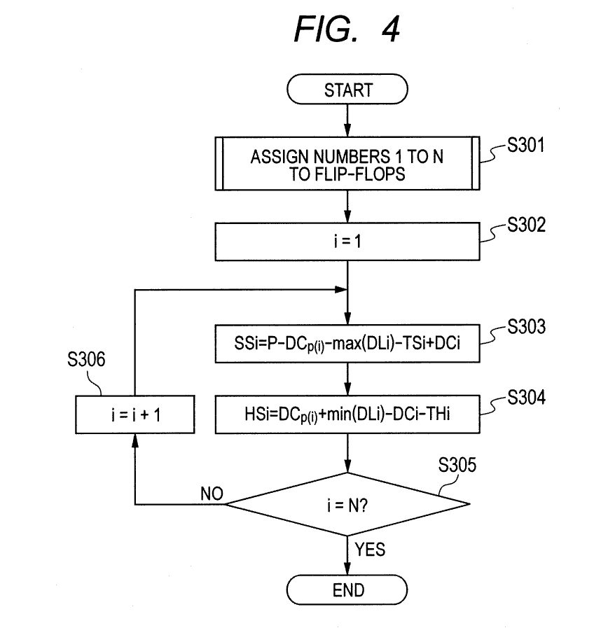

FIG. 4 is a diagram showing the procedure of calculating the setup slack and the hold slack in step S903 in FIG. 3.

With reference to FIG. 4, first, the STA unit 5 arbitrarily assigns numbers to all of (N pieces of) flip-flops in the net list (step S301).

Next, the STA unit 5 sets variable “i” to “1” (step S302). The STA unit 5 calculates the setup slack SSi of the i-th flip-flop Fi in accordance with the following equation.

SSi=P−DCp(i)−max(DLi)−TSi+DCi (5)

where P denotes the cycle of clocks CLK, max(DLi) denotes the maximum data path delay to the flip-flop Fi, TSi indicates the setup constraint of the flip-flop Fi, DCi indicates the initial clock latency of the flip-flop Fi, and DCp(i) expresses the initial clock latency of the flip-flop Fp(i) at the immediately preceding stage which outputs data to the flip-flop Fi. In the case where the flip-flop Fi does not receive data from another flip-flop (that is, in the case where the flip-flop Fi receives data from the primary input), the STA unit 5 sets DCp(i) as “0” and calculates the equation (5) (step S303).

After that, the STA unit 5 calculates the hold slack HSi of the i-th flip-flop in accordance with the following equation.

HSi=DCp(i)+min(DLi)−DCi−THi (6)

where min(DLi) denotes the minimum data path delay to the flip-flop Fi. THi denotes the hold constraint of the flip-flop Fi. DCi denotes the initial clock latency of the flip-flop Fi. DCp(i) denotes the initial clock latency of the flip-flop Fp(i) at the immediately forward stage which outputs data to the flip-flop Fi. In the case where the flip-flop Fi does not receive data from other flip-flops (that is, in the case where the flip-flop Fi receives data from the primary input), the STA unit 5 sets DCp(i) as “0” and calculates the equation (6) (step S304).

In the case where “i” is not N (NO in step S305), the STA unit 5 increments “i” only by one (step S306) and repeats the process from step S303. In the case where “i” is N (YES in step S305), the STA unit 5 finishes the process.

### Procedure of HSLD

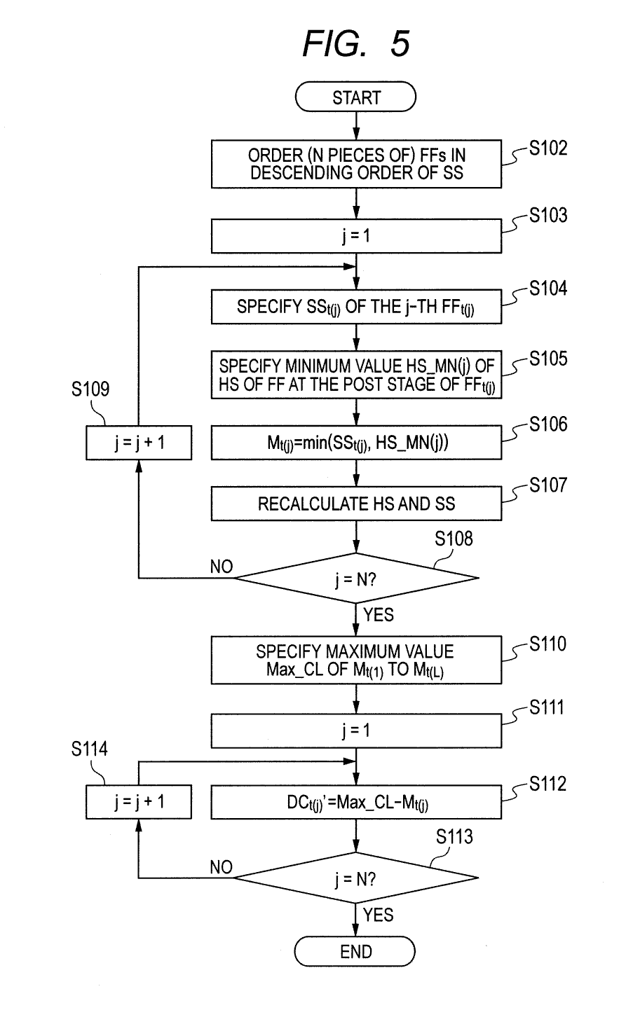

FIG. 5 is a flowchart showing the procedure of HSLD in step S904 in FIG. 3.

With reference to FIG. 5, the HSLD unit 6 arranges all of (N pieces of) flip-flops in the net list in the descending order of the setup slacks SS. It is assumed here that numbers j=1 to N are assigned (step S102).

The HSLD unit 6 sets the variable “j” as 1 (step S103). Next, the HSLD unit 6 specifies the j-th flip-flop F (Ft(j)) ordered in step S102 and specifies the setup slack SSt(j) of the flip-flop Ft(j). For example, in the case where the first flip-flop is F5 when j=1, a setup slack SS5 is specified (step S104).

The HSLD unit 6 selects a flip-flop at the immediately rearward stage which receives data from the flip-flop Ft(j) (the flip-flop at the post stage of the flip-flop Ft(j)). It is assumed here that M(j) pieces of flip-flops are selected. The HSLD unit 6 specifies the minimum value HS_MN(j) of the hold slacks of the selected M(j) pieces of flip-flops in order to specify a flip-flop having the highest possibility of a hold violation among the flip-flops at the post stage of the flip-flop Ft(j) by advancing the clock latency of the flip-flop Ft(j). It is assumed here that HS9 is specified as the minimum value HS_MN(j). In the case where there are no flip-flops at the post stage of the flip-flop Ft(j), the HSLD unit 6 sets a sufficiently large value as the minimum value HS_MN(j) (step S105).

Next, the HSLD unit 6 specifies the smaller one of the setup slack SSt(j) and the hold slack HS_MN(j) as a margin Mt(j). Specifically, in the case where the setup slack SSt(j) is smaller than the minimum value HS_MN(j) of the hold slack, even when the clock latency DCt(j) is advanced only by the setup slack SSt(j), no hold violation occurs in the flip-flops at the post stage. Consequently, the margin Mt(j) is set to SSt(j). On the other hand, when the setup slack SSt(j) is larger than the minimum value HS_MN(j) of the hold slack, if the clock latency DCt(j) is advanced only by the setup slack SSt(j), a hold violation occurs in the flip-flops at the post stage. Therefore, the HSLD unit 6 sets the margin Mt(j) as HS_MN(j) as a limit value at which no hold violation occurs in the flip-flops at the post stage. For example, in the case where SS5<HS9, SS5 is specified as M5. The reason of maximizing the margin (the amount of advancing the clock latency) without causing a setup violation and a hold violation is because the clock latency is easily dispersed by the above operation (step S106).

The HSLD unit 6 recalculates the setup slack and the hold slack. Specifically, the HSLD unit 6 updates the setup slack SSt(j) of the flip-flop Ft(j) to a value obtained by subtracting only Mt(j) from the present value. The HSLD unit 6 updates the hold slack HSt(j) of the flip-flop Ft(j) to a value obtained by adding only Mt(j) to the present value. The HSLD unit 6 updates the setup slack SS of the M(j) pieces of flip-flops at the post stage of the flip-flop Ft(j) to a value obtained by adding only Mt(j) to the present value. The HSLD unit 6 updates the hold slack HS of the M(j) pieces of flip-flops at the post stage of the flip-flop Ft(j) to a value obtained by subtracting only Mt(j) from the present value (step S107).

In the case where “j” is not N (NO in step S108), the HSLD unit 6 increments “j” only by one (step S109) and repeats the process from step S104. In the case where “j” is N (YES in step S108), the HSLD unit 6 specifies the maximum value in the margins Mt(1) to Mt(L) as the maximum clock latency MAX_CL (step S110).

Next, the HSLD unit 6 sets variable “j” to “1” (step S110). The HSLD unit 6 calculates relative clock latency DCt(j)′ by subtracting the margin Mt(j) from the maximum clock latency MAX_CL. By obtaining the relative clock latency in such a manner, following generation of a clock tree and layout design of delay elements based on the clock tree are more facilitated (step S112).

In the case where “j” is not N (NO in step S113), the HSLD unit 6 increments “j” only by one (step S114) and repeats the process from step S112. In the case where “j” is N (YES in step S113), the HSLD unit 6 finishes the process.

The recalculation of the setup slack SS and the hold slack HS in the step S107 is optional and may not be executed depending on the degree of dispersion of the initial clock latency generated by the logic synthesis unit 2.

### EXAMPLE 1 OF PROCESS RESULT

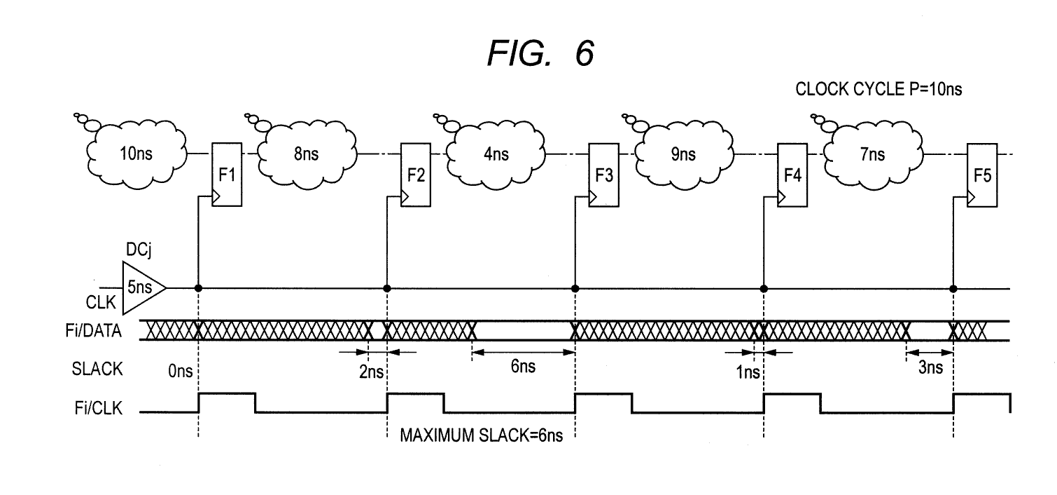

FIG. 6 is a diagram showing an example of clock latency before the HSLD is applied.

Referring to FIG. 6, in the example, clock latencies of five flip-flops F1 to F5 are shown.

The diagram shows setup slack values when the flip-flops F1 to F5 are set as timing end points. It is assumed that the cycle is “10 ns” and propagation delay, a timing check value, and a clock skew in the flip-flops F1 to F5 is “0 ns”.

In designing before application of the HSLD, to supply clock signals whose phase variations are suppressed to the clock terminals of the flip-flops F1 to F5, a delay element of 5 ns is disposed at the origin of the clock tree, and a signal from the delay element is supplied to each of the flip-flops F1 to F5.

To reduce the peak power, there is a method of retarding the phase of a clock to the flip-flop at the ante stage only by the setup slack in consideration of a margin in the timing which is only the amount of the setup slack shown in FIG. 6.

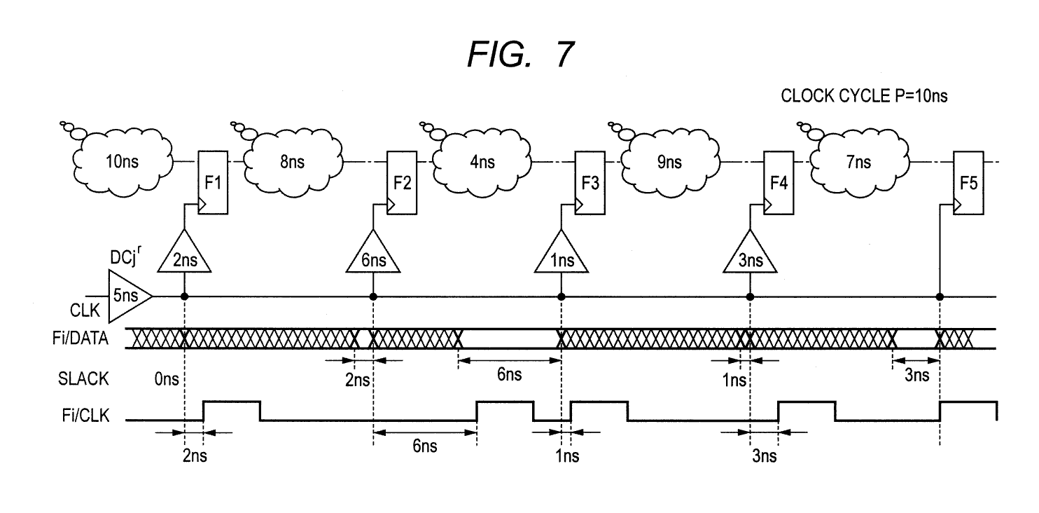

FIG. 7 is a diagram showing an example of clock phases in the method of retarding the phase of a clock in the ante stage only by the amount of the setup slack. In the case of applying the HSLD to the case, evaluation is made in the order of F3→F5→F2→F4→F1. The evaluation order is not changed also after recalculation after determination of the clock latencies.

As shown in FIG. 7, the setup slacks SS of the flip-flops F2, F3, F4, and F5 are 2 ns, 6 ns, 1 ns, and 3 ns, respectively, so that the phases of the clocks to the flip-flops F1, F2, F3, and F4 are retarded by 2 ns, 6 ns, 1 ns, and 3 ns, respectively.

However, for example, the timing path using the flip-flop F2 as the timing start point is not always F3. In the case of retarding the clock phase of the flip-flop F2 by 6 ns using the setup slack “6 ns” of the flip-flop F3, if the flip-flop F3 has another timing start point other than the flip-flop F2, the setup slack of the flip-flop F3 does not become 0 ns. Moreover, since the flip-flop F2 is retarded by 6 ns, another end point becomes a timing violation. That is, it is difficult to adjust, using a setup slack using a certain flip-flop FF as an end point, the clock latency of another flip-flop FF related to the certain flip-flop FF.

In contrast, in the embodiment, to reduce the peak power, the phase of a clock to the flip-flop at the ante stage of the flip-flop having the setup slack is not retarded, but the phase of a clock of the flip-flop itself having a setup slack is advanced.

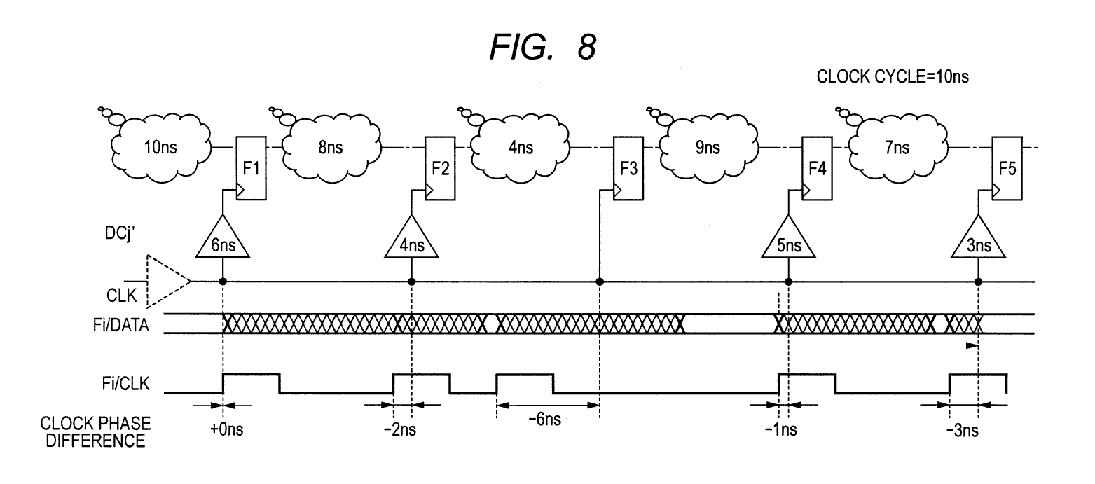

FIG. 8 is a diagram showing an example of clock phases after application of the HSLD of the embodiment. In FIG. 8, the case where the setup slack SSt(j) is smaller than the minimum value HS_MS(j) of the hold slack in step S106 in FIG. 5 is assumed.

Recalculation of the setup slack SS and the hold slack HS in step S107 in FIG. 5 is not executed.

From FIG. 6, it is known that the maximum clock latency MAX_CL is 6 ns. By subtracting each of the setup slack values from 6 ns, the relative clock latencies to the flip-flops F1, F2, F3, F4, and F5 become 6 ns, 4 ns, 0 ns, 5 ns, and 3 ns, respectively.

In the embodiment, the relative clock latencies calculated as described above are assigned to the clock paths. As shown in FIG. 6, delay elements of 6 ns, 4 ns, 0 ns, and 5 ns are provided for the clock paths to the flip-flops F1, F2, F3, and F4, respectively.

### Performance Evaluation

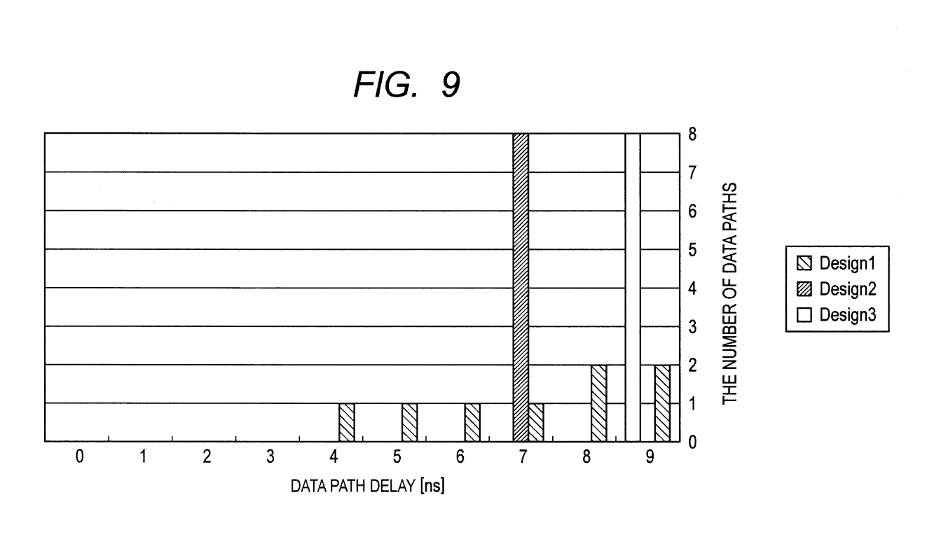

FIG. 9 is a diagram for explaining an example of designs used for evaluating the performance of the embodiment.

It is assumed that, in each of the designs, the number of paths is eight, the horizontal axis expresses data path delay (ns), and the vertical axis indicates the number of data paths having the data path delay.

It is assumed that designs 1 to 3 have the following timing distributions.

In design 1, the number of data paths for each of data path delays “4 to 5 ns”, “5 to 6 ns”, “6 to 7 ns”, and “7 to 8 ns” is one. The number of data paths for each of data path delays “8 to 9 ns” and “9 to 10 ns” is two.

In design 2, all of data path delays in eight data paths are concentrated in 7 to 8 ns.

In design 3, all of path delays in eight data paths are concentrated in 9 to 10 ns.

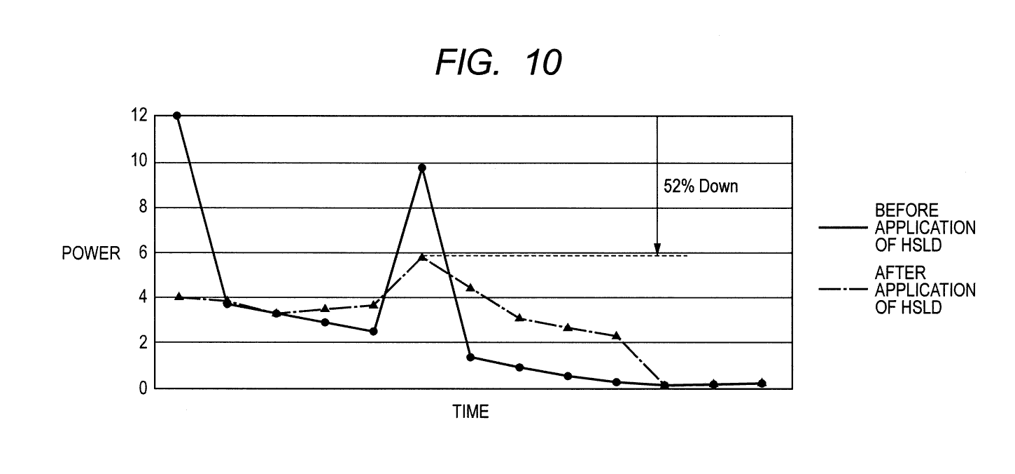

FIG. 10 is a diagram of comparison between power consumption in the case of applying the HSLD of the embodiment and power consumption in the case of a related art in which the HSLD is not applied with respect to the design 1.

In FIG. 10, the horizontal axis expresses time, and the vertical axis indicates power consumption per time. The solid line indicates power consumption in the case where the HSLD is not applied (related method), and the broken line indicates power consumption of the case where the HSLD is applied (the method of the first embodiment).

As shown in FIG. 10, in the related art, the peak power is 12. On the other hand, in the method of the first embodiment, the peak power is suppressed to 5.8. That is, in the method of the embodiment, the peak power can be reduced by 52%.

The reason is that, in the embodiment, since the phase of a clock reaching each of the flip-flops FF can be varied according to the setup slack and the hold slack, the power consumption is dispersed.

In the embodiment, the peak power can be reduced in such a manner, so that the IR drop, EMI noise, and the like can be reduced, and the reliability of the product can be improved.

### EXAMPLE 2 OF PROCESS RESULT

Effects additionally obtained by using the above-described method will now be described.

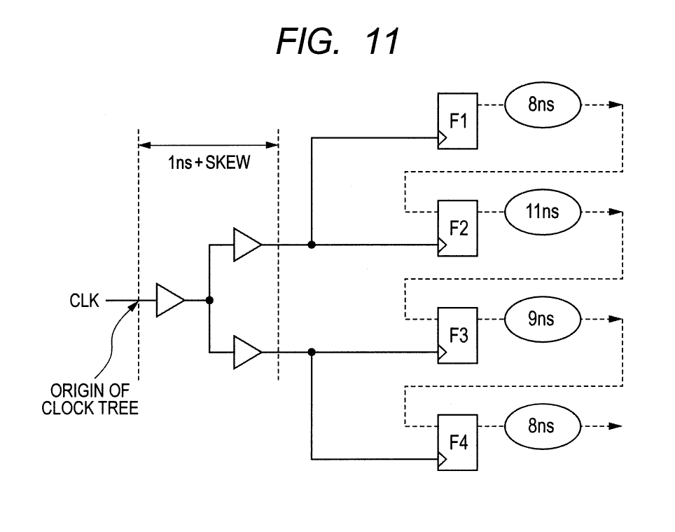

FIG. 11 is a diagram showing an example of a clock tree generated by a method of the related art. In the method of the related art, in many cases, a clock tree is provided at a clock terminal of each of the flip-flops FF. It is assumed that a skew of the clock tree is “0” and a clock needs latency of “1 ns” for satisfying the skew “0” and realizing fan-out division.

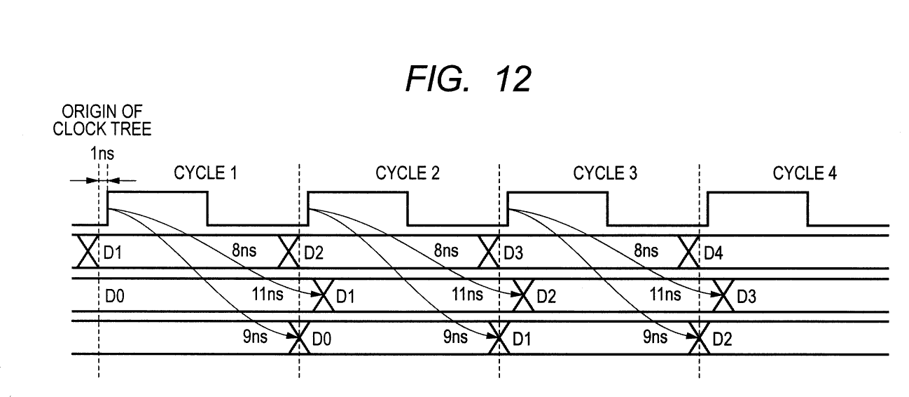

FIG. 12 is a diagram showing a timing chart based on the clock tree of FIG. 11. As shown in FIG. 12, a data path delay from the flip-flop F2 to the flip-flop F3 is 11 ns. Data does not reach the flip-flop F3 before the rising edge of a clock which is supplied to the flip-flop F3, and a setup violation occurs.

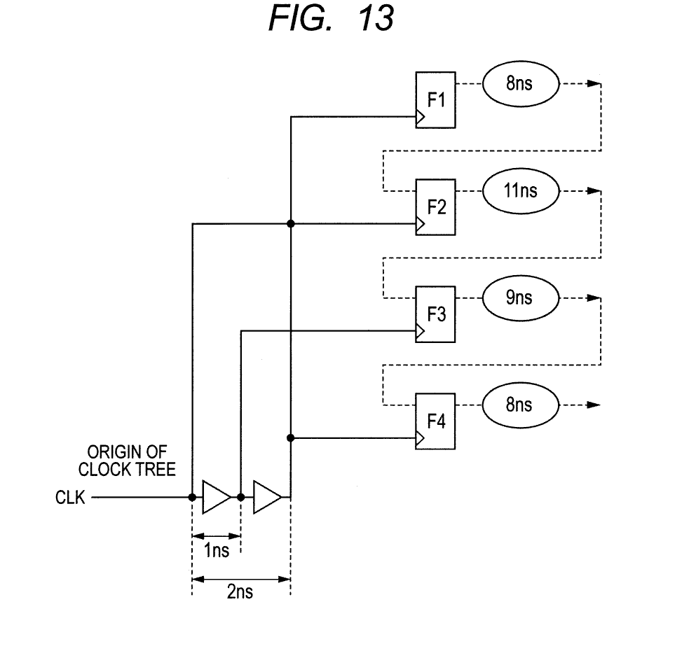

FIG. 13 is a diagram showing an example of a clock tree generated in the embodiment. As shown in FIG. 13, the clock phase is tuned on the basis of the setup slack. Consequently, when there is a setup slack in a forward or rearward clock path, a negative setup slack (that is, timing violation) can be absorbed.

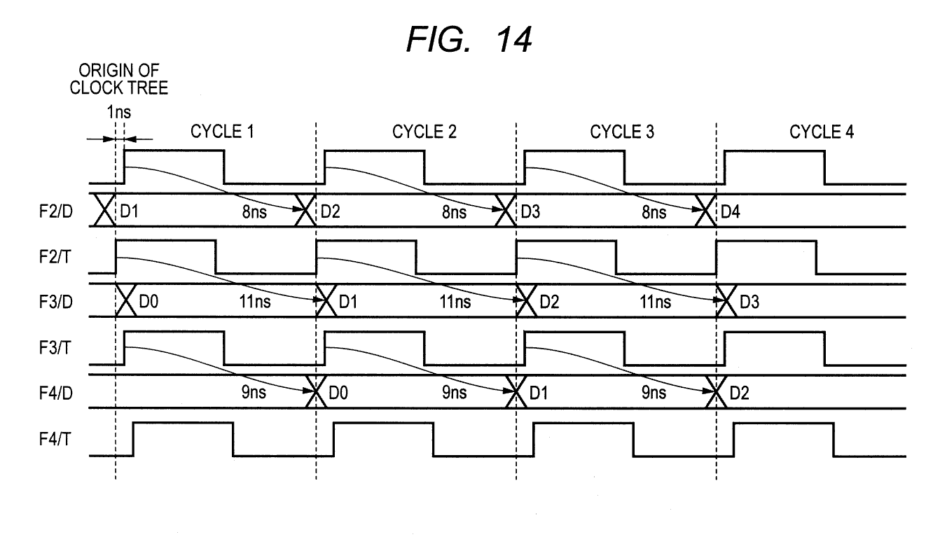

FIG. 14 is a diagram showing a timing chart based on the clock tree of FIG. 13. As shown in FIG. 14, relative clock latencies (phase delays) in the flip-flops F1, F2, F3, and F4 are 2 ns, 0 ns, 1 ns, and 2 ns, respectively. On the other hand, a data path delay from the flip-flop F2 to the flip-flop F3 is 11 ns which exceeds the clock cycle of 10 ns. However, the data path delay from the flip-flop F3 at the next stage to the flip-flop F4 is 9 ns, so that the clock phase of the flip-flop F3 can be retarded only by 1 ns. Therefore, a setup violation as in the method of the related art does not occur.

### Summary

As described above, according to the first embodiment, the phase of a clock reaching each flip-flop is varied according to the setup slack and the hold slack, so that the power consumption timings can be dispersed. Since the power consumption timings can be dispersed in the first embodiment, an IR drop, an EMI noise, and the like can be reduced, and the reliability of the semiconductor device can be improved.

### Second Embodiment

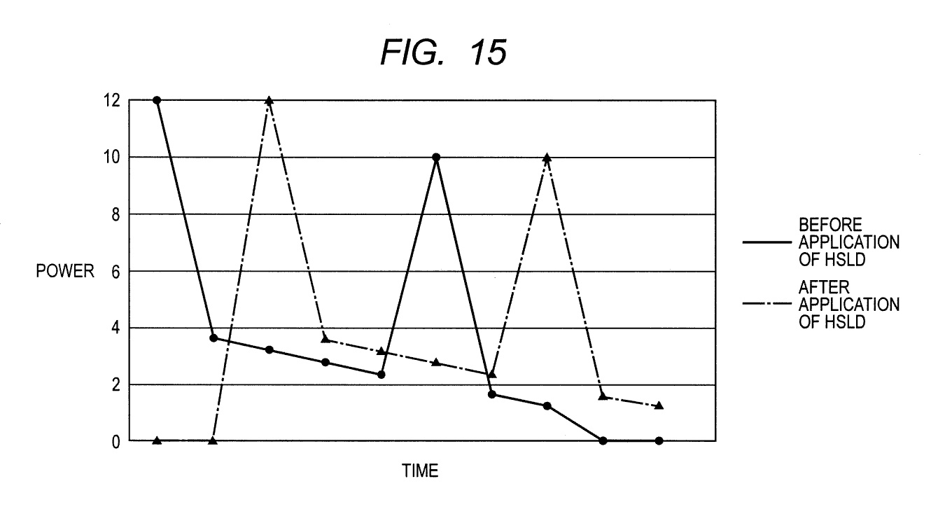

FIG. 15 is a diagram showing comparison between power consumption in the case of applying the HSLD of the embodiment and power consumption in the case of a related art in which the HSLD is not applied with respect to design 2 in FIG. 9.

In the design 2, the setup slacks of all of eight data paths are 3 ns and are concentrated in one point. In such a case, if the setup slacks are regarded as phase delays like in the first embodiment, the clock phases are shifted only by the same value and no dispersion is achieved. As a result, an effect of reducing the peak power is not obtained as shown in FIG. 15.

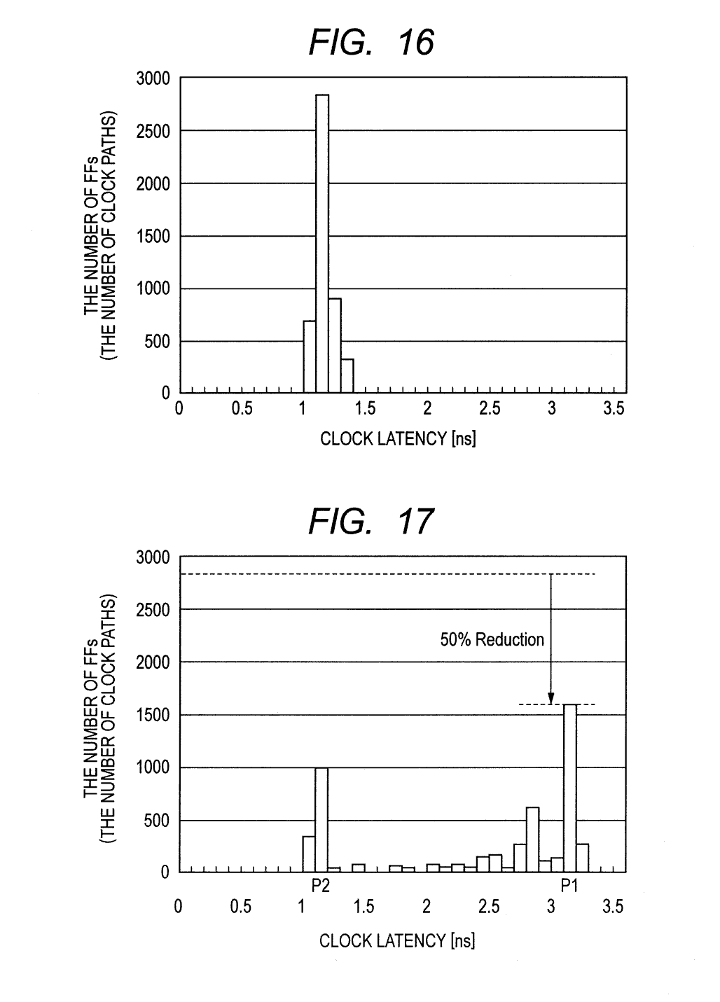

FIG. 16 is a diagram showing a frequency distribution (histogram) of clock latency DC before the HSLD is applied. FIG. 17 is a diagram showing a frequency distribution (histogram) of clock latency DC after the HSLD is applied.

As shown in FIG. 17, there is a case such that although the peak value of frequency is reduced by applying the HDLS, peaks such as P1 and P2 still remain.

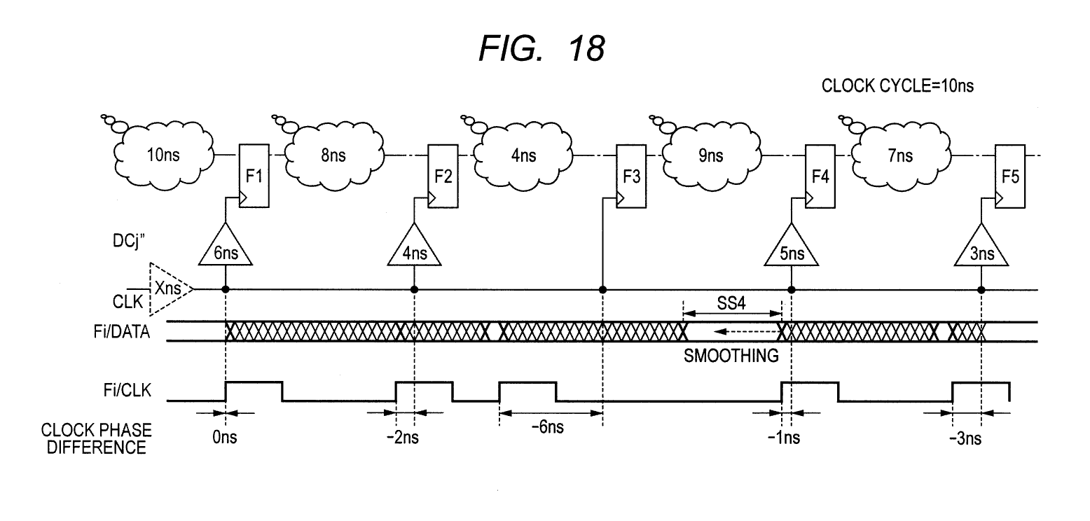

As a result of dispersing the clock latencies by the HSLD, as shown in FIG. 18, actually, there are many clock paths in which the setup slack still remains due to the relation of related clock paths. For example, the clock path to the flip-flop F4 has a setup slack of 6 ns.

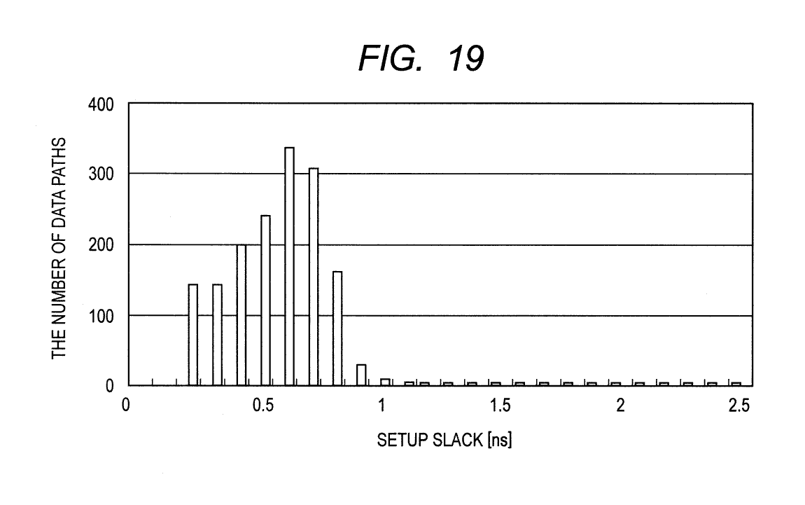

FIG. 19 is a diagram showing a frequency distribution of the setup slack SS after application of the HSLD to the peak P1 in FIG. 17.

It is understood from FIG. 19 that setup slacks are uniformly distributed from 0.1 ns to 2.4 ns. As described above, the setup slacks in the clock paths having the same clock latency often vary after the HSLD. In the second embodiment, by using such a nature, peaks remaining after application of the HSLD are further dispersed (that is, smoothed).

### Configuration of Semiconductor Designing Apparatus

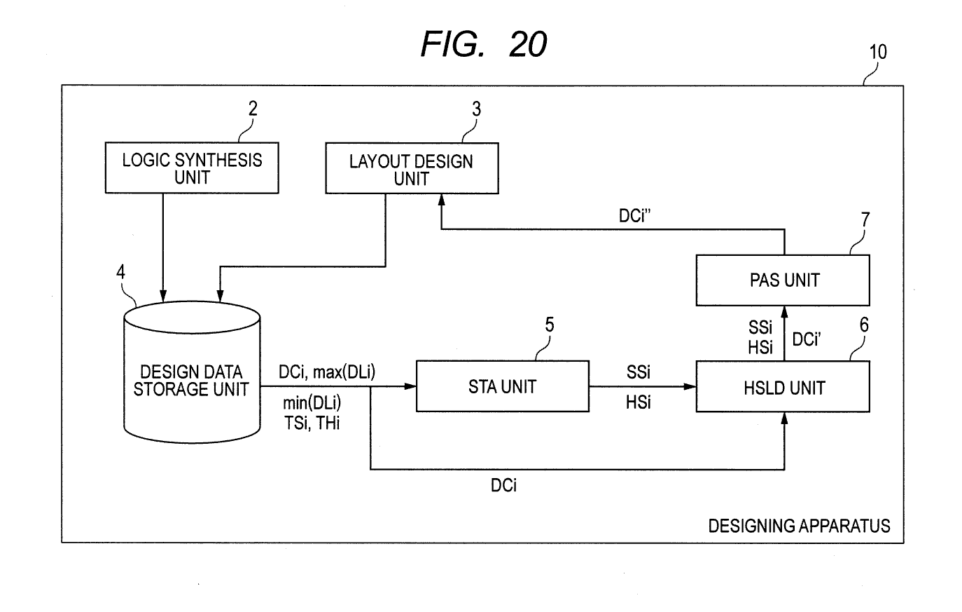

FIG. 20 is a diagram showing the configuration of a semiconductor designing apparatus of a second embodiment.

With reference to FIG. 20, a semiconductor designing apparatus 10 has a PAS (Peak Aware Smoothing) unit 7 in addition.

In the case where the frequency distribution of the clock latency is concentrated in a first value after adjustment of the clock latency by the HSLD unit 6, the PAS unit 7 selects a plurality of flip-flops having the clock latency of the first value. On the basis of the setup slack and the hold slack of each of the selected flip-flops changed by adjustment of the present design value of the clock latency of each of the selected flip-flops (that is, relative clock latency DCt(j)′ calculated by the HSLD unit 6) and adjustment of the clock latency by the HSLD unit 6, the PAS unit 7 adjusts the clock latency of each of the flip-flops selected so as to be advanced more than the present design value without causing a setup violation and a hold violation.

### Operation Procedure

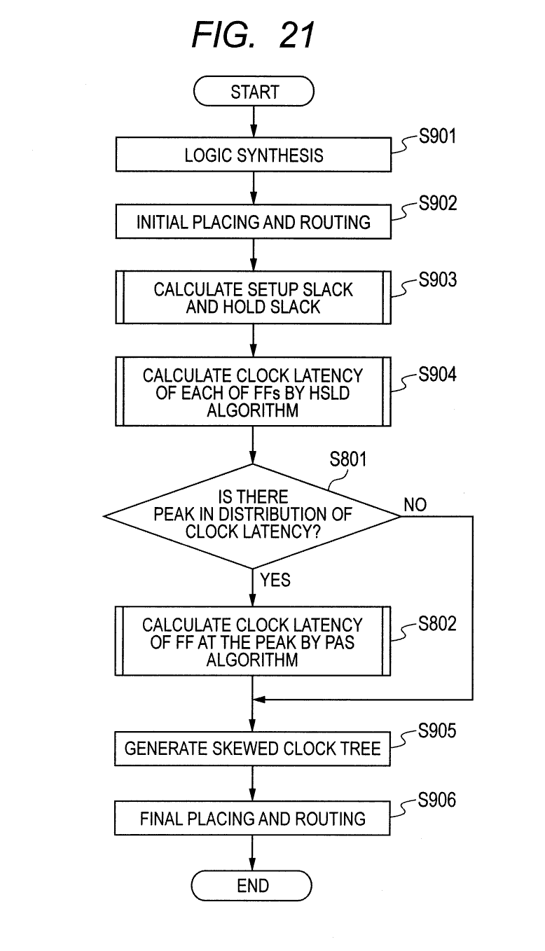

FIG. 21 is a flowchart showing a designing procedure by the semiconductor designing apparatus of the second embodiment.

First, the logic synthesis unit 2 generates an initial net list (including initial clock latency, setup constraint, hold constraint, and data of data path delay) on a clock tree starting from the clock source and extending to a circuit element group at the end from RTL (Register Transfer Level) description configured by a flip-flop and a combination circuit and stores it in the design data storage unit 4 (step S901).

Next, the layout design unit 3 places gates without any space and routes terminals of the gates on the basis of the net list, thereby generating initial layout data, and stores the data in the design data storage unit 4 (step S902).

Using the data included in the initial net list, the STA unit 5 calculates the setup slack and the hold slack of the flip-flop FF (step S903).

The HSLD unit 6 calculates a new clock latency for each of the flip-flops FF on the basis of the setup slack and the hold slack calculated in step S903 (step S904).

The PAS unit 7 generates a frequency distribution of the new clock latency calculated in step S904. The PAS unit 7 checks whether or not there are peaks in the distribution of the clock latencies, that is, whether or not there is any concentration. Concretely, in the case where there is a clock latency whose frequency is equal or higher than a predetermined threshold, the PAS unit 7 determines that there is a peak. In the case where there is a peak in the distribution of the clock latency (YES in step S801), the PAS unit 7 recalculates a new clock latency for the flip-flop FF having the clock latency of the peak on the basis of the setup slack and the hold slack recalculated in step S107 in FIG. 5 (step S802).

The layout design unit 3 updates the net list by reconstructing the clock tree on the basis of the newly calculated clock latency (step S905).

Further, the layout design unit 3 updates the layout data on the basis of the updated net list and stores the updated data in the design data storage unit 4 (step S906).

### PAS

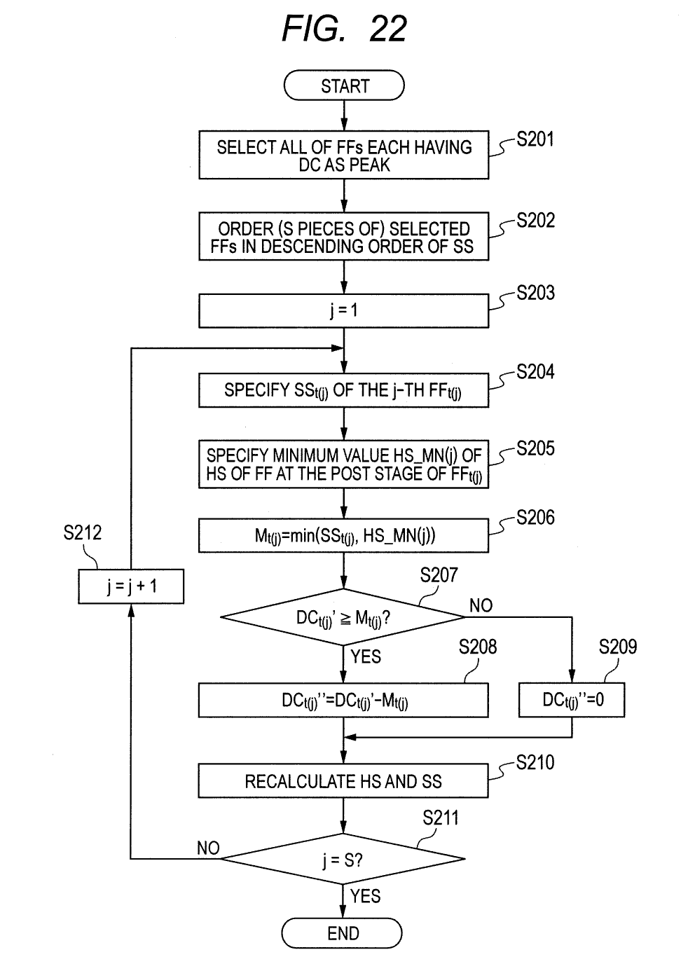

FIG. 22 is a flowchart showing the procedure of PAS in step S202 in FIG. 21.

With reference to FIG. 22, the PAS unit 7 selects all of flip-flops having the clock latency DC specified as a peak. It is assumed here that S pieces of flip-flops are selected (step S201).

Next, the PAS unit 7 arranges the selected S pieces of flip-flops in the descending order of the setup slacks SS. It is assumed here that numbers j=1 to S are assigned (step S202).

The PAS unit 7 sets the variable “j” as 1 (step S203). Next, the PAS unit 7 specifies the j-th flip-flop F (Ft(j)) ordered in step S202 and specifies the setup slack SSt(j) of the flip-flop Ft(j) (step S204).

The PAS unit 7 selects a flip-flop at the immediately rearward stage which receives data from the flip-flop Ft(j) (the flip-flop at the post stage of the flip-flop Ft(j)). It is assumed here that M(j) pieces of flip-flops are selected. The PAS unit 7 specifies the minimum value HS_MN(j) of the hold slacks of the selected M(j) pieces of flip-flops in order to specify a flip-flop having the highest possibility of a hold violation among the flip-flops at the post stage of the flip-flop Ft(j) by advancing the clock latency of the flip-flop Ft(j). In the case where there are no flip-flops at the post stage of the flip-flop Ft(j), the PAS unit 7 sets a sufficiently large value as the minimum value HS_MN(j) (step S205).

Next, the PAS unit 7 specifies the smaller one of the setup slack SSt(j) and the hold slack HS_MN(j) as a margin Mt(j). Specifically, in the case where the setup slack SSt(j) is smaller than the minimum value HS_MN(j) of the hold slack, even when the clock latency DCt(j) is advanced only by the setup slack SSt(j), no hold violation occurs in the flip-flops at the post stage. Consequently, the margin Mt(j) is set to SSt(j). On the other hand, when the setup slack SSt(j) is larger than the minimum value HS_MN(j) of the hold slack, if the clock latency DCt(j) is advanced only by the setup slack SSt(j), a hold violation occurs in the flip-flops at the post stage. Therefore, the PAS unit 7 sets the margin Mt(j) as HS_MN(j) as a limit value at which no hold violation occurs in the flip-flops at the post stage. The reason of maximizing the margin (the amount of advancing the clock latency) without causing a setup violation and a hold violation is because the clock latency is easily dispersed by the above operation (step S206).

When the relative clock latency DCt(j)′ calculated by the HSLD unit 6 is equal to or larger than the margin Mt(j) (YES in step S207), the PAS unit 7 sets an updated value DCt(j)″ of the relative clock latency to a value obtained by subtracting only the margin Mt(j) from DCt(j)′ (step S208). On the other hand, when the relative clock latency DCt(j)′ calculated by the HSLD unit 6 is less than the margin Mt(j) (NO in step S207), the PAS unit 7 sets the updated value DCt(j)″ of the relative clock latency to “0” (step S209).

The PAS unit 7 recalculates the setup slack and the hold slack. Specifically, the PAS unit 7 updates the setup slack SSt(j) of the flip-flop Ft(j) to a value obtained by subtracting only Mt(j) from the present value. The PAS unit 7 updates the hold slack HSt of the flip-flop Ft(j) to a value obtained by adding only Mt(j) to the present value. The PAS unit 7 updates the setup slack SS of the M(j) pieces of flip-flops at the post stage of the flip-flop Ft(j) to a value obtained by adding only Mt(j) to the present value. The PAS unit 7 updates the hold slack HS of the M(j) pieces of flip-flops at the post stage of the flip-flop Ft(j) to a value obtained by subtracting only Mt(j) from the present value.

In the case where “j” is not S (NO in step S211), the PAS unit 7 increments “j” only by one (step S212) and repeats the process from step S204. In the case where “j” is S (YES in step S211), the PAS unit 7 finishes the process.

### Performance Evaluation

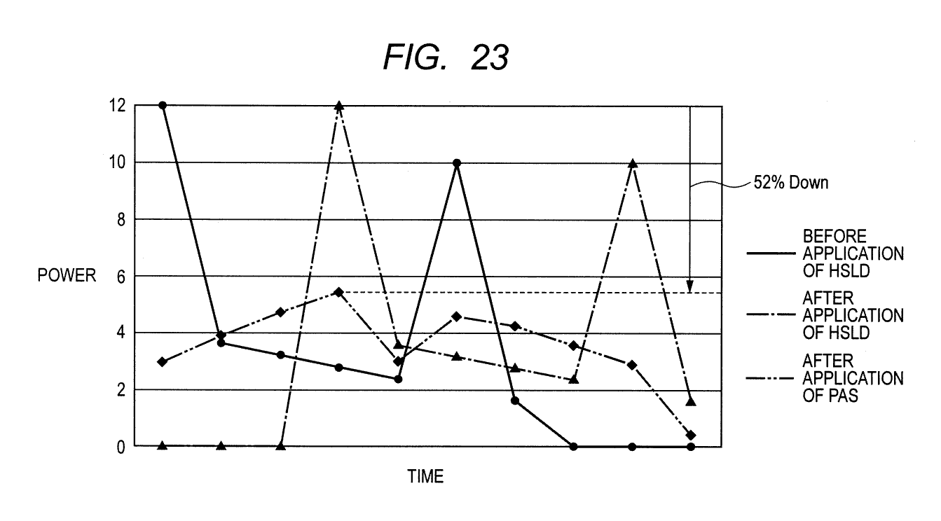

FIG. 23 is a diagram showing comparison among power consumption in the case of applying the HSLD of the first embodiment, power consumption in the case of applying the PAS of the second embodiment in addition to the HSLD of the first embodiment, and power consumption of a related art in which the HSLD is not applied with respect to the design 2 in FIG. 9.

In FIG. 23, the horizontal axis expresses time, and the vertical axis indicates power consumption per time. The solid line indicates power consumption in the case where the HSLD is not applied (related method), the alternate long and short dash line indicates power consumption of the case where the HSLD is applied (the method of the first embodiment), and the alternate long and two short dashes line expresses power consumption of the case where the HSLD is applied and, further, the PAS is applied (the method of the second embodiment).

As shown in FIG. 23, in the related art, the peak power is 12. In contrast, the peak power is 5.8 in the method of the first embodiment, and the peak power is 5.4 in the second embodiment. That is, in the method of the second embodiment, the peak power can be reduced by 55% as compared with that in the method of the related art.

The reason is that, for example, in the first embodiment, even if there is a timing margin of 3 ns, the clock latency in all of clock paths is shifted by 3 ns. In the second embodiment, the clock latencies of 3 ns concentrated in the first embodiment are dispersed by the timing margin generated in the first embodiment.

### Summary

As described above, according to the second embodiment, in the case where peaks of clock latencies remain even after the first embodiment, the clock latencies of the peak can be dispersed in accordance with the setup slack and the hold slack generated in the first embodiment. Consequently, the power consumption timings can be dispersed, an IR drop, an EMI noise, and the like can be reduced, and the reliability of the semiconductor device can be improved.

### Modifications

The present invention is not limited to the foregoing embodiments but includes, for example, the following modifications.

### (1) Clock Latency Adjustment Amount

Although the clock latency is advanced only by the maximum amount without causing a setup violation and a hold violation in the embodiment of the invention, the present invention is not limited to the case. For example, the clock latency may be advanced only by a value obtained by subtracting a predetermined amount from the maximum amount or only by a random amount without causing a setup violation and a hold violation.

It is to be considered that the embodiments disclosed are illustrative and not restrictive in all of the aspects. The scope of the present invention is not defined by the scope of the claims rather than the foregoing description. All changes that fall within meets and bounds of the claims are intended to be embraced.

What is claimed is:

1. A semiconductor designing apparatus for adjusting a clock latency of a flip-flop designed by logic synthesis, comprising:
a slack analysis unit for calculating a setup slack as a margin of setup time of a flip-flop on the basis of a present design value of the clock latency of the flip-flop; and
a first clock latency adjustment unit for adjusting the clock latency of the flip-flop so as to be advanced more than the present design value on the basis of the calculated setup slack without causing a timing violation.

2. The semiconductor designing apparatus according to claim 1,
wherein the slack analysis unit further calculates a hold slack as a margin of hold time of the flip-flop on the basis of a present design value of the clock latency, and
wherein the first clock latency adjustment unit adjusts the clock latency of the flip-flop so as to be advanced more than the present design value on the basis of the setup slack and a hold slack of a flip-flop at the post stage of the flip-flop without causing a setup violation and a hold violation.

3. The semiconductor designing apparatus according to claim 2,
wherein in the case where a plurality of flip-flops are present at the post stage of the flip-flop, the first clock latency adjustment unit adjusts the clock latency of the flip-flop so as to be advanced more than the present design value on the basis of the setup slack and a minimum value of hold slacks of the flip-flops at the post stage of the flip-flop without causing a setup violation and a hold violation.

4. The semiconductor designing apparatus according to claim 3,
wherein in the case where a plurality of flip-flops are present at the post stage of the flip-flop, the first clock latency adjustment unit adjusts the clock latency of the flip-flop so as to be advanced more than the present design value only by an amount of smaller one of the setup slack and the minimum value of hold slacks of the flip-flops at the post stage of the flip-flop.

5. The semiconductor designing apparatus according to claim 1,
wherein, in the case of adjusting clock latencies in a plurality of flip-flops, the first clock latency adjustment unit arranges the flip-flops in the descending order of the setup slacks, adjusts the clock latencies in the flip-flops in the descending order of the setup slacks, and recalculates the setup slack and the hold slack each time the clock latency of each of the flip-flops is adjusted.

6. The semiconductor designing apparatus according to claim 5,
wherein in the case where a plurality of flip-flops are present at the post stage of the flip-flop, the first clock latency adjustment unit sets, as a margin of the flip-flop, the smaller one of the setup slack and the minimum value of hold slacks of the flip-flops at the post stage of the flip-flop, and sets the maximum value of the margin in the flip-flops as a maximum clock latency, and
wherein the first clock latency adjustment unit calculates a relative clock latency of the flip-flop by subtracting the margin of the flip-flop from the maximum clock latency.

7. The semiconductor designing apparatus according to claim 1, wherein also in the case where a data path delay to the flip-flop is longer than a cycle of a clock, the first clock latency adjustment unit adjusts the clock latency of the flip-flop so as to be advanced more than the present design value on the basis of the setup slack.

8. The semiconductor designing apparatus according to claim 1, further comprising a second clock latency adjustment unit, in the case where a frequency distribution of clock latencies is concentrated on a first value after adjustment of the clock latency by the first clock latency adjustment unit, selects a plurality of flip-flops having a clock latency of the first value, and adjusts the clock latency of each of the selected flip-flops so as to be advanced more than the present design value without causing a timing violation on the basis of a present design value of the clock latency of each of the selected flip-flops and a setup slack of each of the selected flip-flops changed by adjustment of the clock latency by the first clock latency adjustment unit.

9. The semiconductor designing apparatus according to claim 8, wherein the second clock latency adjustment unit adjusts the clock latency of each of the selected flip-flops so as to be advanced more than the present design value without causing a setup violation and a hold violation on the basis of a setup slack of each of the selected flip-flops and a hold slack of a flip-flop at the post stage of each of the selected flip-flops changed by adjustment of the clock latency by the first clock latency adjustment unit.

10. The semiconductor designing apparatus according to claim 9, wherein in the case where plurality of flip-flops are present at the post stage of each of the selected flip-flops, the second clock latency adjustment unit adjusts the clock latency of each of the selected flip-flops so as to be advanced more than the present design value without causing a setup violation and a hold violation on the basis of a setup slack of each of the selected flip-flops and a minimum value of hold slacks of the flip-flops at the post stage of each of the selected flip-flops changed by adjustment of the clock latency by the first clock latency adjustment unit.

11. The semiconductor designing apparatus according to claim 10, wherein in the case where a plurality of flip-flops are present at the post stage of each of the selected flip-flops, the second clock latency adjustment unit adjusts the clock latency of each of the selected flip-flops so as to be advanced more than the present design value only by an amount of smaller one of the setup slack of each of the selected flip-flops and the minimum value of hold slacks of the flip-flops at the post stage of each of the selected flip-flops changed by adjustment of the clock latency by the first clock latency adjustment unit.

12. The semiconductor designing apparatus according to claim 8,
wherein the second clock latency adjustment unit arranges the selected flip-flops in the descending order of the setup slacks, and
wherein the second clock latency adjustment unit adjusts the clock latencies in the flip-flops in the descending order of the setup slacks, of the selected flip-flops, and recalculates the setup slack and the hold slack each time the clock latency of each of the flip-flops is adjusted.
